(19) United States
(12) Patent Application Publication
(10) Pub. No.: US 2016/0004517 A1
(43) Pub. Date: Jan. 7, 2016

(54) SOFTWARE DEVELOPMENT IMPROVEMENT TOOL - iREVIEW

(71) Applicant: Bank of America Corporation, Charlotte, NC (US)

(72) Inventor: Jigesh Rajendra Safary, Mumbai (IN)

(21) Appl. No.: 14/320,780

(22) Filed: Jul. 1, 2014

(51) Int. Cl. G06F 9/45; G06F 11/36

(52) U.S. Cl. CPC G06F 8/436; G06F 11/3624

(57) ABSTRACT

Aspects of the disclosure relate to providing a tool for detecting defects in iSeries source code. The tool addresses a requirement of a software development team to review code requirements while developing a software/program. There may be strict coding guidelines if not followed properly, increase likelihood of a programming defect. The tool may scan code written by the software development team to ensure compliance with the coding guidelines and generate a list of defects/warnings in a text file format. The tool may transmit the list of defects/warnings, such as by email, to a manager of the software development team. The tool may measure productivity of the software development team based on the number of defects/warnings reported. The tool may include a control table. The control table may maintain the coding guidelines as rules which may be easily amendable by a user of the tool.

### FIELD OF TECHNOLOGY

Aspects of the disclosure relate to providing apparatus and methods for detecting defects in iSeries source code.

### BACKGROUND

Institutions, such as large corporations, utilize computer code to implement services and products (hereinafter, “products”). The computer code may include programming defects. The computer code may include programming defects as a result of a human or system error. A defect may affect performance of the product. For example, the defect may result in a computer program unexpectedly crashing or other disruptions of functionality. In some instances, the computer code may successfully implement a product, but a defect may result in the product performing inefficiently. As a result of a defect, the product may expose the institution a security risk.

To provide a reliable and secure product, an institution may utilize a mainframe computer such as an iSeries computer produced by International Business Machines of Armonk, N.Y. A mainframe computer is a robust computing machine, designed to provide reliable access to commercial products. Computer code written for iSeries computers may include defects that, if undetected, may degrade performance of a product and may expose the institution to a security risk. It would be desirable to provide a tool for detecting defects present in iSeries source code.

Additionally, in the computing field, a definition of what is considered to be “inefficient” or a “security risk” is constantly evolving. What may not have been deemed a risk yesterday may be considered a risk today. It would be desirable to provide a tool for detecting defects in iSeries source code that is scalable and updateable.

An institution may develop coding guidelines that describe preferred programming practices for developers writing computer code. The guidelines may include instructions that are to be followed by software developers writing source code. It would be desirable to provide a tool for reviewing iSeries source code and ascertaining a level of compliance with the coding guidelines.

It would be desirable therefore to provide apparatus and methods for an iSeries code review tool (“iReview”).

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with the principles of the invention;

FIG. 2 shows an illustrative apparatus in accordance with the principles of the invention;

FIG. 3 shows an illustrative process in accordance with the principles of the invention;

FIG. 4 shows an illustrative process in accordance with the principles of the invention;

FIG. 5 shows an illustrative arrangement in accordance with the principles of the invention; and

FIG. 6 shows illustrative information in accordance with the principles of the invention.

### DETAILED DESCRIPTION OF THE DISCLOSURE

Apparatus and methods for an iSeries code review tool are provided. The tool may be developed based on coding guidelines which a software development team should follow when developing a product. For example, an institution may release coding guidelines that specify security and efficiency standards that are to be followed by software developers. Non-compliance with the guidelines may increase a possibility of a defect being present within source code. Such a defect, if not timely detected during various stages of product testing efforts, may result in an adverse consequence to the institution.

The tool may automate review of iSeries source code. The tool may improve the iSeries software development process and reduce an amount of time needed to review iSeries source code for compliance with coding guidelines.

The tool may retrieve iSeries source code and determine if operations used by source code comply with a set of rules. An iSeries operation may direct the iSeries mainframe computer to perform a specific action. An iSeries operation may define a variable, define a record or provide any suitable instruction to a compiler. The set of rules may be determined based on the coding guidelines. The rules implementing coding guidelines may be turned on/off based on a business need of the institution. Rule violations and a result of the automated review may be transmitted to a software developer.

Automated source code review may improve coding consistency across an institution and improve uniform compliance with coding guidelines. Automated reviews of source code may be scheduled regularly. Regularly scheduled reviews of source code may maintain a level of consistency in software design and implementation. Detection of defects in the source code may reduce a security risk associated with software and improve a quality of the software.

Utilization of the tool may result in discovery of defects or “bugs” in the source code at an early in development of the software, when the defects are relatively easy to fix. For example, detecting the defects an early stage in development of a product may pose relative risk to the institution than detecting defects after deployment of the product.

The iSeries code review tool is configured to scan source code written for iSeries and detect compliance and/or non-compliance of the source code with institutional coding guidelines. The tool may produce a list of detected defects and/or warnings associated with the source code. The tool may produce a list of detected compliant operations associated with the source code. The list may be output to a text file. The text file may be emailed to a software developer or to a manager of a software development team. The list may provide information for rating productivity a software developer. The list may provide information for rating quality of source code produced by a software developer. For example, the developer may be scored based on a number of defects/warnings reported for a given source code file.

As a result of reviewing defects detected by the tool, members of a software development team may improve their understanding of iSeries operations and coding guidelines. Communication of defects via email may streamline root cause analysis and provide a productivity performance measurement for software developers. An electronic copy of defects detected by the tool may be used to update other automated quality control tools as Quality Center produced by Hewlett-Packard Co. of Palo Alto, Calif.

Configuring the tool may include expressing coding guidelines as computer readable rules. The rules may be stored in a control table. Rules stored in a control table may be changed or deleted. New rules may be added to a control table. A control table may correspond to coding guidelines. When coding guidelines are changed, the control table may be changes as well. The change to control table may allow the tool to determine whether source code complies with rules corresponding to the changed coding guidelines.

Rules corresponding to the coding guidelines may be stored in one or more control tables. For a given iSeries source code file, the tool may identify an appropriate control table based on one or more characteristics of the source code. For example, the tool may identify a control table based on an iSeries programming language used to write the source code or an operation performed by the source code.

Rules stored in the control table may be easily updated following a change to coding guidelines. By using an architecture that relies on a control table to store the rules, the tool may be easily adapted to changes in coding guidelines. For example, an update to the control table may allow updated guidelines to be applied to future reviews of iSeries source code without writing new computer code for the tool. Use of a control table may provide a versatile tool that may be utilized independent of programming language, hardware, operation or other characteristic of the source code.

A plurality of control tables may be created. Each control table may correspond to a property of an iSeries source code file. For example, each iSeries programming language may be associated with a control table. A control table may include rules developed specifically for the corresponding iSeries language. The tool may be used to detect defects in source code written in any of the iSeries programming languages by calling an appropriate control table.

The tool may be configured to identify an appropriate control table for the source code being reviewed. For example, the tool may identify a first control table based on the language used by the source code. The tool may review the source code using rules stored in the first control table.

The tool may identify a second control table for the source code. The second control table may be identified based on a specific operation performed by the source code. The specific operation may include a table operation such as sorting or filtering. The specific operation may include a database operation such as queries, push, pull and delete. The specific operations may be unique to iSeries, such as record based operations. The specific operations may include a unique format for iSeries—such as coding using a columnar format.

The second control table may include rules directed to the specific operation. The tool may determine compliance of the iSeries code with coding guidelines based on applying the rules in the one or more control tables to the source code.

Methods for detecting a defect in computer source code written for iSeries are provided. The methods may be implemented using one more computer systems.

The methods may include determining an iSeries program language used to write computer source code. The program language may be selected from a group consisting of: a Report Program Generator (“RPG”) language for iSeries, store procedure (“SP”) language for iSeries and a Control Language (“CL”) for iSeries.

The methods may include identifying an operation performed by the source code. The operation may be an iSeries table operation. The table operation may include dynamic sorting, filtering or populating of table contents.

After identifying the operation, a control table may be searched to determine if the control table includes an entry associated with the detected operation. An entry in the control table may include one or more rules for the detected operation. Upon detecting that the source code includes an operation associated with an entry in the control table, the tool may evaluate whether the operations complies with one or more rules associated with the operation.

In some embodiments, an operation may be detected based on an entry in a control table. Each entry in the control table may correspond to an operation that is associated with a rule. The tool may examine a selected control table and determine whether the source code includes an operation listed in the control table. When the tool determines that the source code includes an operation listed in the control table, the tool may evaluate a rule corresponding to the operation.

A rule may be a format, permissible inputs to the operation or other property that coding guidelines assign to the operation. An identified operation may be evaluated to determine if the operation complies with the rule in the control table.

If an identified operation does not comply with a rule in the control table, the tool may register a defect in the source code. The defect may be a non-compliant operation and/or a non-compliant input to the operation. Upon detection of the defect, the methods may include registering the detected defect. Registering the defect may include recording information about the defect such as identity of the non-compliant operation, a location of the non-compliant operation within the source code, an exemplary compliant version of the operation, identification of the source code file that contained the defect and any other suitable characteristic of the source code that includes the defect. The tool may copy the non-compliant operation to a text file. The tool may increment a counter that tallies a number of non-compliant operations detected within a source code file.

When the tool determines that the source code is expressed using the RPG language for iSeries, tool may be configured to evaluate one or more of the rules listed below in List 1. The rules included in List 1 include illustrative iSeries operations and exemplary rules associated with each operation. The rule may search for a presence of one of the operations in List 1. The rule may be violated if an operator and/or operator format is absent from the source code. The rule may be violated if a format is detected in source code.

List 1: Illustrative RPG language rules and operations.

| Illustrative iSeries | Illustrative rule for |
|---|---|
| operation | the iSeries operation |
| H-Spec compilation | Does the source code include |
| parameters | the compilation parameters |
| F, I, O and E | Does the source identify record |
| indicators | types using the F, I, O and E |
| | indicators |
| structured query | Does the source code include |
| language (“SQL”) | processing options to be used for |
| SETOPTON | SQL statements? |
| *LR-INDICATOR | Is this indicator present in the |
| | source code? |
| (RRN, COUNT(*), *, PF) | Does a SQL select operation |
| | include this non-compliant |
| | format? |
| (PF, WITH NC) | Does a SQL insert operation |
| | include this non-compliant |
| | format? |
| (PF, RRN) | Does a SQL update or delete |
| | operation include this non- |
| | compliant format? |

For each rule/operation included in List 1, the tool may evaluate compliance of the source code with each of the rules corresponding to the operation. The entry itself may be a rule. For example, the entry may include a specific format for the operation. The entry may include a format that is forbidden by coding guidelines. The control table may include “general rules” that are not associated with a particular operation. A general rule may be applied globally to a portion of, or all of, a source code file.

For example, general rules may include verifying that the source code file includes a threshold number of modification tags, that there are no defined and unused variables in the source code or that the source code does not include a variable assigned a length greater than 50 characters.

A rule may cause the tool to examine the source code and determine whether the code includes H-Spec parameters. The H-Spec parameters are compile-time parameters. An exemplary compile time parameter may compile the program such that the program expects dates in the format “mm/dd/yyyy.”

A rule may cause the tool to examine the source code and determine whether iSeries records are defined. An iSeries program may define a record using F, I, O or E indicators. An “F” corresponds to a “file” record. An “I” corresponds to an input record. An “O” corresponds to an output record. An “E” corresponds to an exception record.

The tool may cause the tool to examine the source code and determine if the code includes a “*LR-INDICATOR.” The *LR-INDICATOR may correspond to the end of the program.

A rule may cause the tool to examine the source code and determine if the code includes an operator that includes a “PF” flag. The PF flag indicates that the operator is applied to a “physical file.” Coding guidelines may prefer that developers apply operators to an SQL file rather than the physical file.

A rule may cause the tool to examine the source code for “processor intensive” operators. For example, an operator may include a “select *” flag that applies an operator to a relatively large number of records. The tool may detect such operators.

A rule may cause the tool to examine the source code for an operator that includes a “NC” flag. The “NC” flag indicates that the operator is applied in a non-commit manner and does not change a record. Coding guidelines may eschew non-commit operators. If the operator is to be applied, then it should be applied as a “commit” and result in a change to the record.

A rule may cause the tool to examine the source code for an operator that includes a “RRN” flag. An RRN flag indicates that the operator is applied to a record. Coding guidelines may state that the operator should be applied using an account number or borrower ID and not using the record identifier.

If an operation detected within the source code is not associated with an entry in the control table, the tool may proceed to examine another line of the source code or another identified operation. In a preferred embodiment, the tool may only detect and identify operations that are associated with one or more rules in a control table that has been associated with the source code. The tool may search for operations within the source code based on entries in the control table.

The source code may include a program written in the CL language for iSeries. The tool may determine whether the computer source code complies with one or more rules for a CL program. List 2 includes illustrative rules for source code written using the iSeries CL language.

List 2: Illustrative rules for iSeries CL language operations.
Source code must include a modification tag describing the CL program.
Source code must not include a defined and unused variable.
Source code must not include a command attempts to establish unauthorized access to a system or violate security setting.
Source code must include a command label.

Source code may include a table operation. The table operation may be applied to data stored in a table referenced in the source code. For example, a table operation may insert a new row into a table or filter information stored in the table. The tool may determine whether a table and/or the table operation comply with coding guidelines. Table rules may include verifying that memory has been allocated for the table and has a sufficient amount of memory space been allocated. Illustrative table rules are presented below in List 3. The tool may evaluate whether the source code complies with one or more of the illustrative rules. Rule compliance may correspond to affirmative detection of a rule target. Rule compliance may correspond to a failure to detect a rule target. If a table does not comply with a rule, the tool may register a defect. Registering the defect may include inserting a copy of the non-compliant table and/or table operation into a text file.

List 3: Illustrative table rules.
Does the table include a modification tag describing the table?
Does the table include a primary key?
Does the table include a pre-determined record format?
Does the table include a label?
Does each column within the table include a label?
Does the table include a column having a NULL value?
Does a column in the table include a DEFAULT Value?
Does a column in the table include a VARCHAR designation?
Does a column in the table include an ALLOCATE designation?
Does a column in the table include a CACHE designation?

When the tool determines that the source code is expressed using the SP language for iSeries, tool may be configured to evaluate the rules associated with the SP language. For example, the SP language may be used to implement a database operation. The database operation may operate on information stored in a database. An operation within the source code may access the database. For example, a database operation may delete, insert, update or select a record. The database operation may include a structured query language (“SQL”) instruction command. The tool may determine whether the source code includes a database operation corresponding to an entry in a control table.

When the tool determines that the source code includes a program expressed using the SP language for iSeries, tool may be configured to evaluate one or more of the rules listed below in List 4. The rules included in List 4 include illustrative iSeries operations and exemplary rules associated with each operation. The rule may search for a presence of one of the operations in List 4. The rule may be violated if an operator and/or format is absent/present from the source code. Illustrative rules are presented below in List 4.

List 4: Illustrative rules for iSeries SP language operations.
Does the source code include a modification tag describing operation of the SP program? If not register a defect.
Does the SP program include a defined and unused variable? If yes register a defect.
Does the SP program include a SQL SETOPTON command? If not register a defect.
Does the SP program include a SQL exception handler? If not register a defect.
Register a defect when input parameter to a SQL select operation includes (RRN, COUNT(*), *, PF).
Register a defect when input parameter to a SQL insert operation includes (PF, WITH NC).
Register a defect when input parameter to a SQL input operation includes (PF, RRN).
Register a defect when input parameter to a SQL delete operation includes (PF, RRN).

A presence of a non-compliant operation may be a defect in the source code. In response to detection of a defect within the source code, the methods may include registering the defect. Registering the defect may include storing the detected defect in a text file. The text file may be transmitted a pre-determined email address.

The tool may be configured to identify a first coding team of developers who bear primary responsible for the development of the source code. The first team may input source code to the tool. The first coding team may be responsible for using the tool to conduct an initial examination of the source for defects. The first coding team may be responsible for correcting any defects detected in the source code.

Based on a number of detected defects associated with source code produced and corrected by the first coding team, the tool may be run by a centralized code review team. The centralized code review team may deploy the tool to conduct further review the source code and detect any defects. For example, if a threshold number of defects are detected by an initial examination by the tool, the centralized code review team may use the tool to conduct further examination of the source code. Further review of the source code by a second coding team such as the centralized review team may reduce an occurrence of future defects within the source code. The centralized review team may confirm that defects detected in the source code have been cured. If the centralized review team detects that defects are still present in the source code, the first coding team may be directed to cure the defects.

Based on a number of defects associated with a source code file, the tool may calculate a quality score for the source code. The quality score may indicate a risk that the source code may malfunction, perform in a manner unanticipated by developers of the source code or includes operations that do not comply with a coding guideline.

A quality score for the source code may be based on a total number of defects and a weight assigned to each defect. The weight assigned to a defect may be determined based on an estimated cost to an institution of deploying source code that includes the defect. The cost may be a time cost associated with curing the defect. An exemplary time cost may include an estimate of time needed to cure the defect.

In some embodiments, the tool may graphically depict the time cost to cure each of the detected defects. For example, each detected defect may be represented on an X axis. The Y axis may represent time. For each detected defect, the tool may generate a line along the Y axis showing an estimated amount of developer time needed to cure the defect.

A defect may be weighted based on a severity of the defect. For example, coding guidelines may recommend that software developers do not include specific iSeries operations in source code. Each of the specific iSeries operations may be weighted based on a level of risk associated with each operation. If the operation is associated with a relatively high level of risk, the corresponding defect may be associated with a relatively higher weight.

The methods may include monitoring a number of defects associated with each of a plurality of computer programs written for iSeries. The methods may include monitoring each of the plurality of iSeries programs during a pre-determined period of time. The methods may include calculating a coding consistency score based on the number of defects associated with each of the plurality of programs.

Each of the plurality of iSeries programs may be associated with one development team. Each of the plurality of iSeries programs may be associated with multiple development teams. Each of the multiple development teams may produce software for a single line-of-business operated by the institution. Each of the multiple development teams may produce software components of a product offered by the institution. Consistency scores may be calculated on a product basis, team basis, line-of-business basis or any other suitable criteria.

Apparatus may include a tool for reviewing iSeries source code. The tool may include a computer, memory, a processor and other suitable hardware components. The tool may be programmed with computer readable program code. The computer readable program code may be stored in a non-transitory computer readable media. The computer readable program code, when executed by the processor, causes the tool to implement a procedure for reviewing iSeries source code.

The tool may be programmed to retrieve iSeries source code. The tool may determine a code type associated with the iSeries source code. The code type may be selected from a group consisting of an iSeries program written using the RPG language, an iSeries program written using the SP language and/or an iSeries program written using the CL language.

The tool may retrieve a control table associated with the code type. The control table may include iSeries operations that, as a result of coding guidelines, are linked within the control table to a rule. The rule may specify a format for an iSeries operation. The rule may include impermissible operation properties, impermissible instruction definitions or impermissible operator formats. Impermissible properties or definitions may not cause compilation errors. An operation or definition may be deemed impermissible as a result of a potential security risk, financial risk, performance risk or any other suitable consideration.

Some rules may detect whether the source code includes an impermissible operation or operation format. Some rules may detect whether the source code affirmatively includes an operation, indicator (e.g., F, I, O, or E record indicator or end-of-file indicator), threshold number of modification tags or otherwise verify that a developer has followed programming practices recommended by coding guidelines.

For example, a database operation may specify “PF” indicating an iSeries operation is applied to a physical file. Coding guidelines may specify that an SQL file is preferred over the physical file. As a further example, a database write operation may include a “NC” or non-commit flag. The NC flag indicates that the requested write operation does “not commit,” or permanently store the written information. Coding guidelines may discourage use of iSeries operations that include the NC flag.

The tool may parse each line of the iSeries source code. For each parsed line of iSeries source code, the tool may be configured to determine whether the parsed line includes an iSeries operation corresponding to an entry in a control table. For each operation that does correspond to an entry in a control table, the tool may be configured to evaluate a rule associated with the entry.

When the source code is written in RPG language, the control table may include a plurality of rules such as those shown above in List 1.

When a detected iSeries operation does not conform to requirements of a rule, the tool may store the non-compliant iSeries operation in an output file. Based on a total number of non-compliant operations in the output file, and an estimated cost associated with each non-compliant operation, the tool may generate a cost estimate associated with the iSeries source code. The cost estimate may represent a potential financial impact resulting from deployment of the non-compliant iSeries operations included in the source code. The cost may represent a time cost to cure detected defects. The time cost may be determined based on an hourly fee paid to a code developer to repair one or more defects.

The tool may transmit the output file and the cost estimate to a developer that produced the iSeries source code. The cost estimate and number of detected errors in the source code may motivate the developer to be more vigilant of current coding guidelines during future iSeries coding activities.

When iSeries source code is written using the CL language, the control table may include rules such as those shown above in List 2.

When the iSeries source code includes an operation performed on a table, the tool may determine whether a line of source code includes an iSeries operation that references a table property. The table property may correspond to a modification tag describing the table, a primary key for the table, a pre-determined record format, a label for the table, a label for columns of the table, values stored within cells of the table and/or any other suitable table property. When a table is referenced within source code, the tool may verify that columns within the table include information that conforms to coding guidelines. Illustrative coding guidelines are shown above in List 3.

The tool may identify a line of source code expressed using the SP language. For the SP language, the tool may access a control table to obtain a rule associated with the SP language. Illustrative SP language rules are shown above in List 4.

Methods for detecting a defect in source code written for iSeries are provided. The methods may include receiving an iSeries source code file. For each line of the iSeries source code, the methods may identify an iSeries operation within the line of code.

The methods may include identifying a control table that includes a rule for the detected operation. The control table may be identified based on a programming language used in the line of source code. The tool may determine whether the operation corresponds to an entry in the control table. Each entry in the control table may correspond to an operation that is associated with a coding guideline rule. The coding guideline rule may specify a property or characteristic for the operation.

When the operation does not comply with a rule in the control table, the tool copies the operation to an output file. The tool may transmit the output file to a developer of the iSeries source code. By receiving the output file, the developer is made aware of operations included in source code that are non-compliant with coding guidelines.

When the iSeries programming language is RPG, the entry in the control table may be selected from a group consisting of:
a variable having a length greater than 50 characters;
a threshold number of modification tags;
a defined and unused variable;
a H-Spec compilation parameters;
a F, I, O or E record indicators;
a SQL SETOPTON operator;
a *LR-INDICATOR operator;
a (RRN, COUNT(*),*, PF) operator;
a (PF, WITH NC) operator;
a (PF, RRN) operator; and
a (PF, RRN) operator.

When the iSeries programming language is CL, the entry in the control table may selected from a group consisting of:
a modification tag describing the CL program;
a command label;
a defined and unused variable; and
an unauthorized command.

When the iSeries operation references a table, the entry in the control table may be selected from a group consisting of:
a NULL value;
a DEFAULT Value;
a VARCHAR designation;
an ALLOCATE designation; and
a CACHE designation.

When the iSeries operation comprises a database operation, the entry in the control table may be selected from a group consisting of:
a modification tag;
a defined and unused variable;
a SQL SETOPTON operation;
a SQL exception handler;
a SQL select operator that includes a (RRN, COUNT(*), *, PF) input;
a SQL insert operator that includes a (PF, WITH NC) input;
a SQL update operator that includes a (PF, RRN) input; and
a SQL delete operator that includes a (PF, RRN) input.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention. The methods of the above-referenced embodiments may involve the use of any combination of methods, portions of methods, partially executed methods, elements, one or more steps, computer-executable instructions, or computer-readable data structures disclosed herein.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

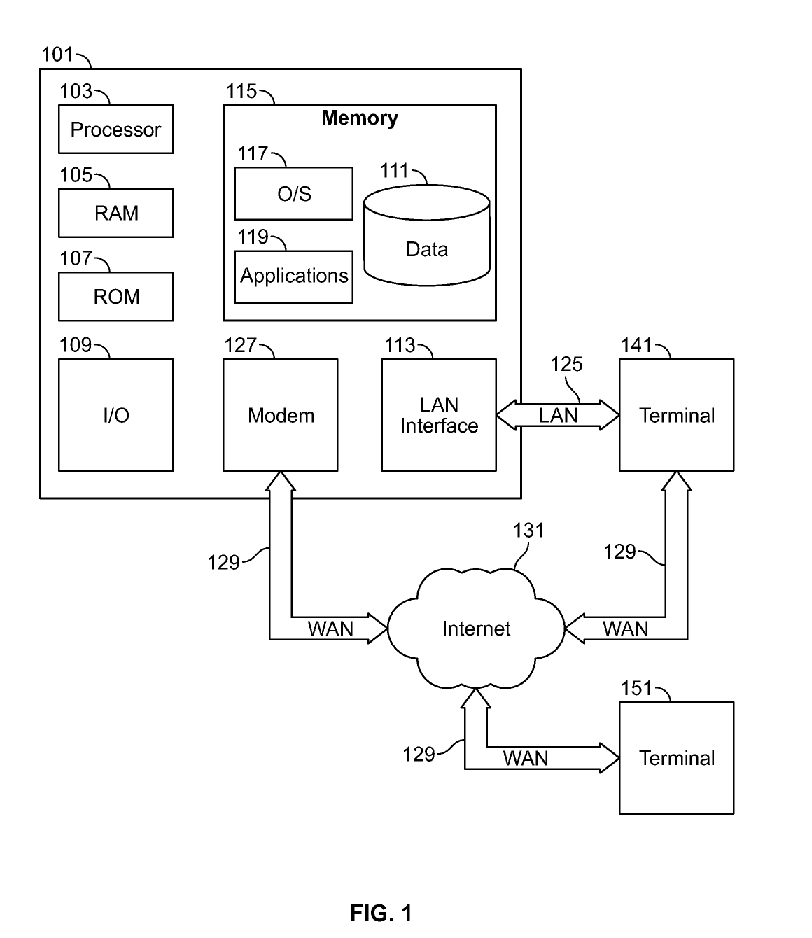

FIG. 1 is a block diagram that illustrates a computing device 101 (alternatively referred to herein as a “server or computer”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touch screen and/or stylus through which a user of device 101 may provide input, and may also include one or more of a speaker for providing audio output and a video display device for providing textual, audiovisual and/or graphical output. Software may be stored within memory 115 and/or other storage (not shown) to provide instructions to processor 103 for enabling server 101 to perform various functions. For example, memory 115 may store software used by server 101, such as an operating system 117, application programs 119, and an associated database 111. Alternatively, some or all of computer executable instructions of server 101 may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown). Terminal 151 and/or terminal 141 may be portable devices such as a laptop, tablet, smartphone or any other suitable device for receiving, storing, transmitting and/or displaying relevant information.

Any information described above in connection with database 111, and any other suitable information, may be stored in memory 115. One or more of applications 119 may include one or more algorithms that may be used to parse source code, evaluate rules, detect defects, produce output files and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

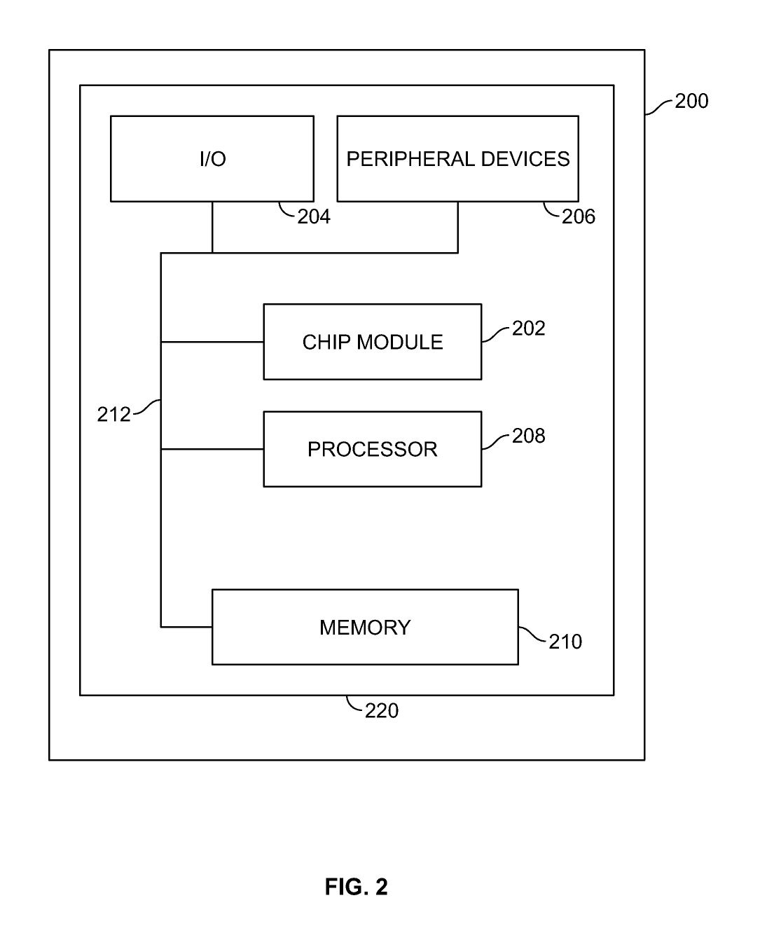

FIG. 2 shows an illustrative apparatus that may be configured in accordance with the principles of the invention.

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data, quantify indices; and machine-readable memory 210.

Machine-readable memory 210 may be configured to store in machine-readable data structures: exception reports, rules tables, lexical items tables, computer code and any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

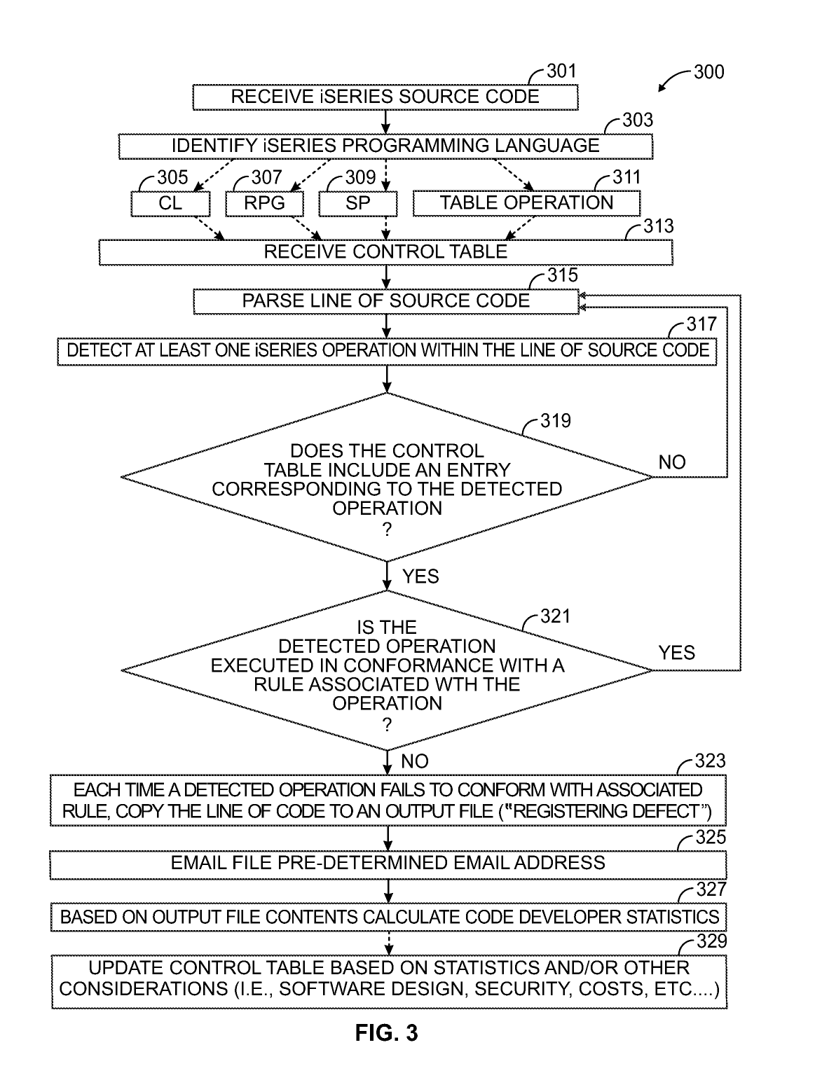

FIG. 3 shows illustrative process 300. For the sake of illustration, one or more of the steps of the process illustrated in FIG. 3 will be described as being performed by a “system.” The “system” may include one or more of the features of the apparatus or processes shown in FIGS. 1-2 and/or any other suitable device or approach. The “system” may be provided by an entity. The system may be a software development process improvement tool for iSeries.

Process 300 may begin at step 301. At step 301 the system receives iSeries source code. At step 303 the system identifies an iSeries programming language used in the source code. The iSeries source code may include one or more programming languages. Each language used in the source code may be identified.

At steps 305-311, the system may determine whether the source code includes CL programming language, RPG programming language, SP programming language and/or a table operation. The system may determine whether the source code includes one or more of the CL programming language, RPG programming language, SP programming language and/or a table operation. Some embodiments, the system may apply a default control table to source code. The default control table may include default rules. Exemplary default rules include determining whether the source code:
includes an invalid library
is invalid
includes and invalid member
includes a member type not supported by the tool
is not associated with any detected defects

At step 313, the system receives a control table. The control table may include rules associated with the detected language and/or operation. At step 315, the system parses each line of source code. At step 317, the system determines whether at least one iSeries operation within the line of source code. At step 319, the system evaluates whether the control table include an entry corresponding to the detected operation.

When the control table does not include an entry corresponding to the detected operation, then process 300 returns to step 317, and parses another line of the source code.

When the control table includes an entry corresponding to the detected operation, then at step 321, the system evaluates whether the detected operation is executed (or formatted to execute) in confirmation with a rule associated with the operation. If the detected operation is coded in conformance with the rule, then process 300 returns to step 315.

When the detected operation is not compliant with the rule, then at step 323, the system copies at least a portion of the line of code to an output file each time a detected operation fails to conform to an associated rule. At step 327, the system emails the file pre-determined email address.

At step 327, based on contents of the output file, the system calculates statistics for the developer that authored the source code. In some embodiments, at step 329, the system updates the control table based on the calculated statistics and/or other considerations such as software design considerations, security considerations, costs considerations, etc.

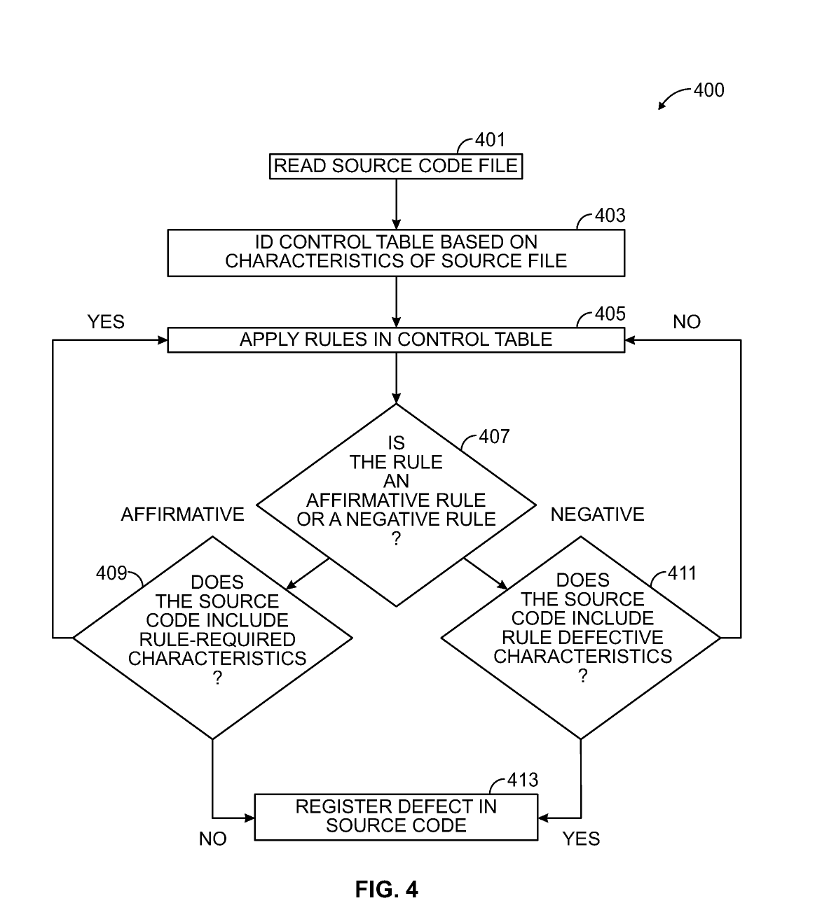

FIG. 4 shows illustrative process 400. For the sake of illustration, one or more of the steps of the process illustrated in FIG. 4 will be described as being performed by a “system.” The “system” may include one or more of the features of the apparatus or processes shown in FIGS. 1-3 and/or any other suitable device or approach. The “system” may be provided by an entity. The system may be a software development process improvement tool for iSeries.

Process 400 may begin at step 401. At step 401, the system reads a source code file. A user of the system may specify a location for the source code file. At step 403, the system identifies a control table based on one or more characteristics of the source code file. The characteristics may include a computer language used in the source code file, an operator used in the source code file, a format or flag associated with the operator or any suitable characteristic of a source code file.

At step 405, the system applies one or more rules stored in the control table to the source code file. The system may examine the source code and determine if the source code complies with the one or more rules stored in the control file.

At step 407, the system determines whether a rule stored in the source file is an affirmative rule or a negative rule. An affirmative rule will cause the tool to examine the source code and determine whether the source code includes a specified operator, flag, format or other suitable characteristic. A negative rule will cause the tool to examine the source code and verify that the source code does not include a specified operator, flag, format or other characteristic.

At step 409, if the rule is an affirmative rule, the system determines whether the source code includes a rule-required characteristic. If the source code includes the rule-required characteristic, the system returns to step 405 and continues to apply rules stored in the control table to the source code file. If the source code does not include the rule-required characteristic, the system proceeds to step 413. At step 413, the system registers an error. The error corresponds to a failure of the source code file to include the rule-required characteristic.

If the system determines at step 407 that the rule is a negative rule, at step 411 the system examines the source code for compliance with the negative rule. The system examines whether the source code includes the operator, flag, format or other characteristic forbidden by the rule. If the system detects a violation of the negative rule, at step 413 a defect is registered. If the system does not detect a violation of the negative rule, the system returns to step 405.

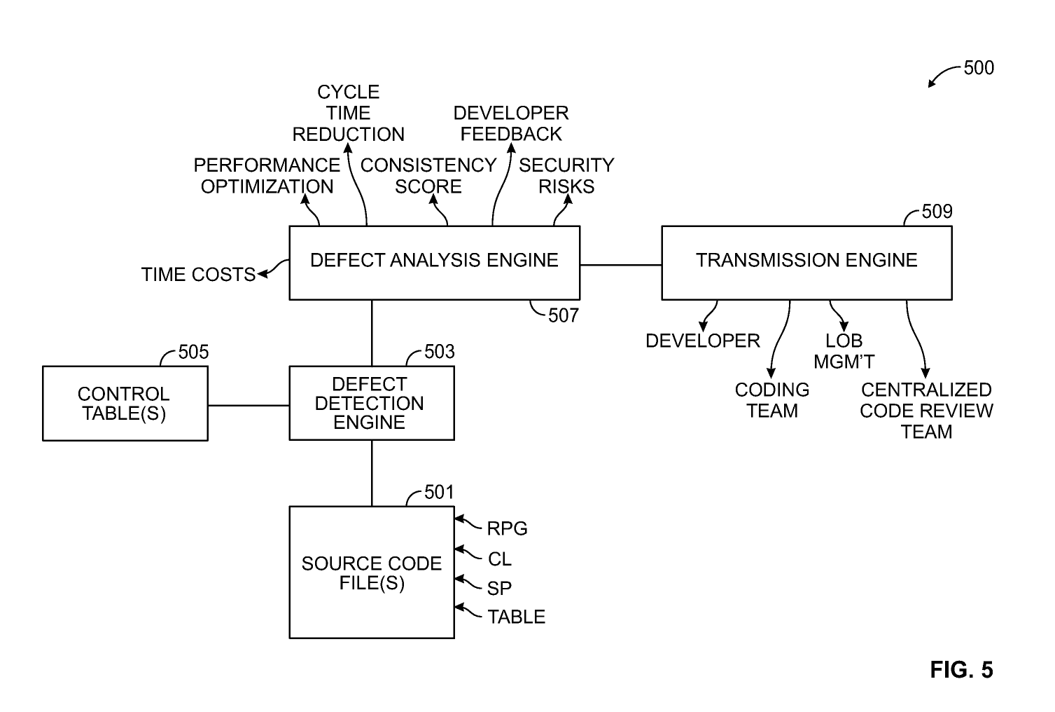

FIG. 5 shows illustrative arrangement 500. Arrangement 500 includes source code file 501. Source code file 501 may include code written in RPG, CL and/or SP languages for iSeries. Source code file 501 may include operators that are applied to one or more tables.

Source code file 501 may be input into defect detection engine 503. Defect detection engine 503 may apply one or more rules stored in control table 505 to source code file 501. Applying rules stored in control table 505 to source code file 501 may identify one or more defects in source code file 501. Detected defects may be input into defect analysis engine 507.

Defect analysis engine 507 may calculate a time-cost for each defect. Defect analysis engine 507 may determine how the source code may be optimized to reduce processing overhead or improve operating efficiency (i.e., improve execution time). Defect analysis engine 507 may determine a relationship between the detected defects and an improved/reduced cycle time. A cycle time may correspond to time elapsed from a coding of a program until commercial deployment of the program. Defect analysis engine 507 may calculate a consistency score for the developer that wrote the source code file. Defect analysis engine 507 may identify defects associated with a security risk. Defect analysis engine 507 may provide a historical comparison of quantity and weight of defects detected in other source code files written by the developer or other suitable developer feedback.

An output generated by defect analysis engine 507 and/or defect detection engine 503 may be transmitted using transmission engine 509. Transmission engine 509 may transmit an output of defect analysis engine 507 to a developer that wrote the source code file, other members of a coding team, management of a line-of-business, a centralized code review team or any other suitable party.

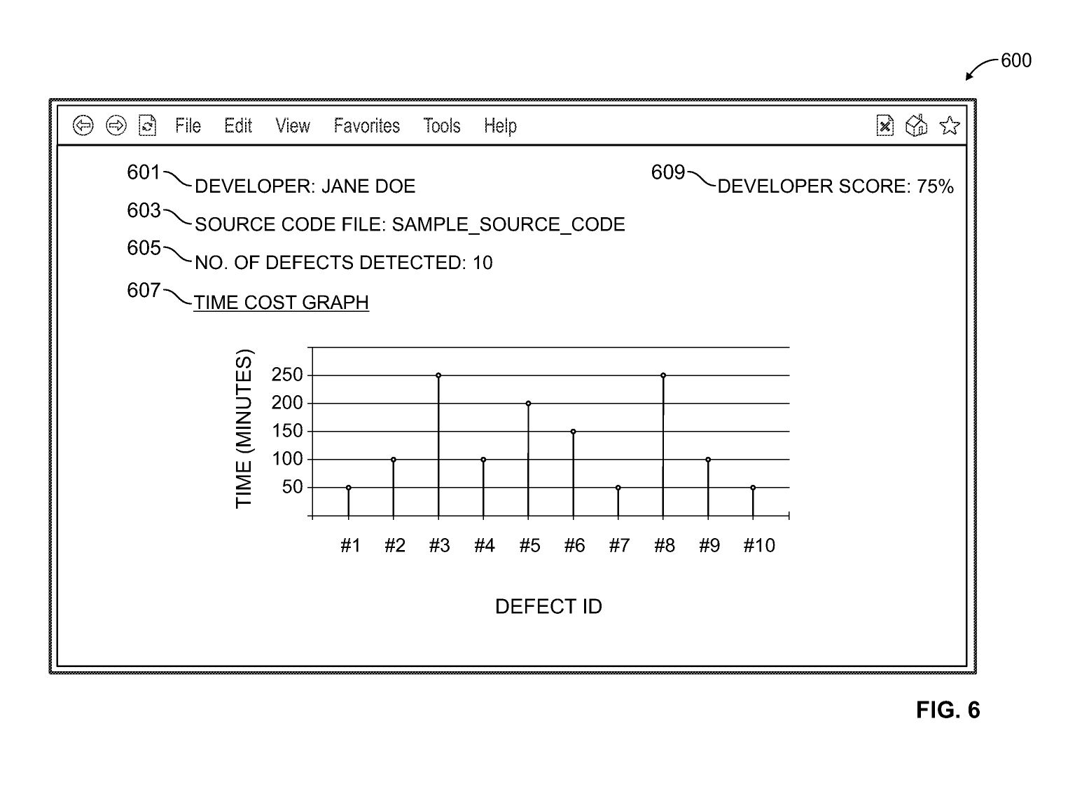

FIG. 6 shows illustrative information 600. Information 600 shows an illustrative transmission may be formulated and transmitted by transmission engine 509 (shown in FIG. 5). Information 600 identifies developer 601, source code file 603 and number of defects 605 detected in the source code file.

Information 600 includes time-cost graph 607. Time cost-graph 607 shows a time-cost associated with each of the defects detected in source code file 603. Developer score 609 may be determined, at least in part, based on information shown in time-cost graph 607.

Thus, systems and methods for a software development process improvement tool for iSeries—iReview have been provided. Persons skilled in the art will appreciate that the present invention can be practiced by other than the described embodiments, which are presented for purposes of illustration rather than of limitation. The present invention is limited only by the claims that follow.

What is claimed is:

1. A method implemented by a software tool for detecting a defect in source code written for an iSeries mainframe computer, the method comprising:
determining an iSeries program language used to write the source code, the program language selected from a group consisting of:
a report program generator (“RPG”) language for iSeries;
a control language (“CL”) for iSeries; and
a store procedure (“SP”) language for iSeries;
for the RPG language, examining the source code for RPG targets corresponding to:
a threshold number of modification tags;
a defined and unused RPG variable;
a variable having a threshold length of 50 characters;
H-Spec compilation parameters;
F, I, O or E record indicators;
a SQL SETOPTON operator;
a *LR-INDICATOR operator;
a SQL select operator that includes (RRN, COUNT(*),*, PF);
a SQL insert operator that includes (PF, WITH NC);
a SQL update operator that includes (PF, RRN); and
a SQL delete operator that includes (PF, RRN);
for the CL language, examining the source code for CL targets corresponding to:
at least one modification tag;
a defined and unused CL variable;
an unauthorized command; and
a command label;
for the SP language, examining the source code for SP targets corresponding to:
a modification tag;
a defined and unused SP variable;
a SQL SETOPTON operator;
a SQL exception handler;
a SQL select operator that includes (RRN, COUNT(*), *, PF);
a SQL insert operator that includes (PF, WITH NC);
a SQL update operator that includes (PF, RRN); and
a SQL delete operator that includes (PF, RRN);
when the source code comprises a table operation, examining the source code for table targets corresponding to:
a modification tag describing the table;
a primary key;
a pre-determined record format;
a label for the table;
a label for columns within the table;
a column that comprises:
a NULL value;
a DEFAULT value;
a VARCHAR designation;
an ALLOCATE designation; or
a CACHE designation;
based on the examining of the source code for the RPG targets, examining of the source code for the CL targets, examining of the source code for the SP targets and examining of the source code for the table targets, evaluating whether the source code complies with a rule associated with the source code; and
in response to an evaluation that the source code does not comply with the rule, registering a defect in the source code.

2. The method of claim 1 wherein the source code does not comply with the rule when the examining fails to detect within the source code:
at least one of the RPG targets corresponding to:
the threshold number of modification tags;
the H-Spec compilation parameters;
the F, I, O or E record indicators;
the SQL SETOPTON operator; or
the *LR-INDICATOR operator;
at least one of the CL targets corresponding to:
the at least one modification tag; or
the command label;
at least one of the SP targets corresponding to:
the modification tag;
the SQL SETOPTON operator; or
the SQL exception handler; and
at least one of the table targets corresponding to:
the modification tag describing the table;
the primary key;
the pre-determined record format;
the label for the table; or
the label for columns within the table.

3. The method of claim 1 wherein the source code does not comply with the rule when the examining detects a presence of:
at least one of the RPG targets corresponding to:
the defined and unused RPG variable;
the variable having a threshold length of 50 characters;
the SQL select operator that includes (RRN, COUNT(*),*, PF);
the SQL insert operator that includes (PF, WITH NC);
the SQL update operator that includes (PF, RRN); or
the SQL delete operator that includes (PF, RRN);
at least one of the CL targets corresponding to:
the defined and unused CL variable; or
the unauthorized command; and
at least one of the SP targets corresponding to:
the defined and unused SP variable;
the SQL select operator that includes (RRN, COUNT(*), *, PF);
the SQL insert operator that includes (PF, WITH NC);
the SQL update operator that includes (PF, RRN); or
the SQL delete operator that includes (PF, RRN).

4. The method of claim 1 further comprising in response to registering the defect, storing a line of the source code that includes the defect in a text file and transmitting the text file to a pre-determined email address.

5. The method of claim 1 further comprising:
determining a total number of registered defects associated with the source code and a time cost associated with each defect; and
generating a time cost estimate associated with the source code; and
storing the time cost estimate in the text file prior to the transmitting the text file.

6. The method of claim 1 further comprising:
registering each defect detected in the source code;
identifying a coding team responsible for correcting the defects in the source code; and
in response to detecting a threshold number of defects, assigning detection of defects in the source code to a centralized coding team.

7. The method of claim 1, further comprising:
registering each defect associated with the source code; and
determining a quality score for the source code based on a total number of registered defects and a time cost assigned to each registered defect.

8. The method of claim 1 further comprising:
monitoring a number of registered defects associated with a plurality of source code files written for iSeries during a pre-determined period of time; and
calculating a coding consistency score based on the number of registered defects.

9. A software review tool comprising a processor and being programmed with computer readable program code stored in a non-transitory computer readable media, such that the computer readable program code, when executed by the processor, causes the tool to:
retrieve iSeries source code from a pre-determined location;
determine a code type associated with the iSeries source code, the code type selected from a group consisting of an iSeries record program generator (“RPG”) program an iSeries control language (“CL”) program and a store procedure (“SP”) program;
retrieve a control table comprising a plurality of rules for the selected code type;
parse each line of the iSeries source code and determine whether the line complies with each of the plurality of rules; and
for each non-compliant line in the source code:
store the non-compliant line in an output file; and
transmit the output file a developer of the iSeries source code;
wherein the plurality of rules detect whether the source code comprises:
a defined and unused variable;
an unauthorized command;
a variable having a length greater than 50 characters;
a (RRN, COUNT(*),*, PF) operator;
a (PF, WITH NC) operator;
a (PF, RRN) operator;
a SQL SETOPTON operation;
a SQL (RRN, COUNT(*), *, PF) operation;
a SQL (PF, WITH NC) operation; and
a SQL (PF, RRN) operation.

10. The tool of claim 9 further programmed to:
determine a total number of non-compliant lines listed in the output file and a time cost associated with each non-compliant operation;
generate a time cost estimate associated with the iSeries source code; and
store the time cost estimate in the output file prior to the transmitting the output file.

11. The computer of claim 9, wherein the plurality of rules detect whether the source code comprises:
a H-Spec compilation parameters;
a F, I, O or E record indicators;
a SQL SETOPTON operator;
a SQL exception handler;
a *LR-INDICATOR operator;
a modification tag;
a command label; and
a threshold number of modification tags.

12. The computer of claim 11 wherein the unauthorized command violates a security setting associated with the iSeries source code.

13. The computer of claim 9 wherein when the iSeries source code comprises a table, the plurality of rules detect whether the table comprises:
a modification tag describing the table;
a primary key for the table;
a pre-determined record format;
a label for the table; and
a label for columns within the table.

14. The computer of claim 13 wherein the plurality of rules detect whether a column of the table comprises:
a NULL value;
a DEFAULT value;
a VARCHAR designation;
an ALLOCATE designation; and
a CACHE designation.

15. A method of detecting a programming defect in source code written for iSeries, the method comprising:
receiving an iSeries source code file;
for each line of the iSeries source code, identifying an iSeries operation;
identifying a control table based on a programming language of the iSeries source code and the identity of the operation;
determining whether a format of the operation corresponds to an entry in the control table;
when the format of the operation corresponds to the entry in the control table copying the operation to an output file; and
transmitting the output file to a developer of the iSeries source code.
wherein when the programming language is record program generator (“RPG”), control language (“CL”) or store procedure (“SP”), the entry in the control table comprises a format selected from the group consisting of:
(RRN, COUNT(*),*, PF);
(PF, WITH NC);
(PF, RRN); and
(PF, RRN).

16. The method of claim 15 wherein, when the programming language is CL, the method further comprises detecting whether the source code comprises:
a modification tag;
a command label;
a defined and unused variable; and
an unauthorized command.

17. The method of claim 15 wherein, when the programming language is RPG, the method further comprises detecting whether the source code comprises:
a variable having a length greater than 50 characters;
a threshold number of modification tags;
a defined and unused variable;
a H-Spec compilation parameters;
a F, I, O or E record indicators for each record referenced in the source code;
a SQL SETOPTON operator; and
a *LR-INDICATOR operator.

18. The method of claim 15 wherein, when the operation manipulates a table, the method further comprises detected whether a column in the table comprises:
a NULL value;
a DEFAULT value;
a VARCHAR designation;
an ALLOCATE designation; and
a CACHE designation.

19. The method of claim 15 wherein, when the programming language is SP, the method further comprises detecting whether the source code comprises:
a modification tag;
a defined and unused variable;
a SQL SETOPTON operation; and
a SQL exception handler.
